(19) United States
(12) Patent Application Publication
(10) Pub. No.: US 2024/0101054 A1
(43) Pub. Date: Mar. 28, 2024

(54) IN-VEHICLE DEVICE AND METHOD FOR STARTING THE SAME

(71) Applicant: DENSO CORPORATION, Kariya-city (JP)

(72) Inventors: Makoto MANABE, Kariya-city (JP); Masato MIYAKE, Kariya-city (JP); Makiko TAUCHI, Kariya-city (JP); Shigeru KAJIOKA, Kariya-city (JP)

(21) Appl. No.: 18/528,549

(22) Filed: Dec. 4, 2023

Related U.S. Application Data
(63) Continuation of application No. PCT/JP2022/026360, filed on Jun. 30, 2022.

(30) Foreign Application Priority Data
Jul. 2, 2021 (JP) 2021-110911

(51) Int. Cl. B60R 16/023; G07C 5/00

(52) U.S. Cl. CPC B60R 16/0232; G07C 5/008

(57) ABSTRACT

An in-vehicle device includes a first controller and a second controller. The first controller includes at least one physical core for executing a first unit related to control of hardware and a second unit related to provision of a service. The second controller starts the first controller in response to occurrence of a start trigger. The first controller starts the first unit, and then starts the second unit when the first controller is started by the second controller. The first unit and the second unit are restarted when an abnormality of the first unit is detected by the second controller or an abnormality of the second unit is detected by the first unit. The first unit, the second unit and the second controller are restarted when an abnormality of the second controller is detected by the second controller.

### CROSS REFERENCE TO RELATED APPLICATIONS

The present application is a continuation application of International Patent Application No. PCT/JP2022/026360 filed on Jun. 30, 2022, which designated the U.S. and claims the benefit of priority from Japanese Patent Application No. 2021-110911 filed on Jul. 2, 2021, the entire contents of which are incorporated herein by reference.

### TECHNICAL FIELD

The present disclosure relates to an in-vehicle device capable of accessing a cloud and a method for starting the in-vehicle device.

### BACKGROUND

An in-vehicle device includes a real-time operating system (hereinafter, referred to as RTOS) and a general-purpose operating system (hereinafter, referred to as GPOS). The RTOS has a high real-time responsiveness while the GPOS does not have such a high real-time responsiveness.

### SUMMARY

According to an aspect of the disclosure, an in-vehicle device is capable of accessing a cloud via a communication unit of a vehicle. The in-vehicle device includes a first controller and a second controller. The first controller has at least one physical core configured to execute a first unit to execute processing related to control of hardware, and a second unit to execute processing related to provision of a service. The second controller is configured to start the first controller in response to occurrence of a start trigger. The first controller is configured to start the first unit earlier than the second unit when the first controller is started by the second controller. The second controller is configured to detect an abnormality of the first unit and an abnormality of the second controller. The first unit is configured to detect an abnormality of the second unit. The second controller is configured to restart the first unit and the second unit when the abnormality of the first unit or the abnormality of the second unit is detected. The second controller is configured to restart the first unit, the second unit and the second controller when the abnormality of the second controller is detected.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a block diagram illustrating a configuration of a mobility loT system.

FIG. 2 is a block diagram illustrating a configuration of a data collection device.

FIG. 3 is a block diagram illustrating a configuration of a program of the data collection device.

FIG. 4 is a block diagram illustrating programs for executing each function of the data collection device.

FIG. 5 is a state-transition diagram of operation modes of the data collection device.

FIG. 6 is a flowchart of a starting process.

FIG. 7 is a flowchart of a second MC monitoring process.

FIG. 8 is a flowchart of a first unit monitoring process.

FIG. 9 is a flowchart of a process for shifting to a low power mode.

FIG. 10 is a flowchart of process for shifting to a stop mode.

FIG. 11 is a block diagram illustrating a connection state when multiple ECUs including data collection devices are mounted on a vehicle.

FIG. 12 is a block diagram illustrating a configuration of a program of a data collection device according to a modification.

### DETAILED DESCRIPTION

According to a comparative example, an in-vehicle device includes a real-time operating system (hereinafter, referred to as RTOS) and a general-purpose operating system (hereinafter, referred to as GPOS). The RTOS has a high real-time responsiveness while the GPOS does not have such a high real-time responsiveness.

However, as a result of detailed studies by the inventors, an issue has been found that it is necessary to appropriately monitor the GPOS and the RTOS in order to improve reliability of such an in-vehicle device. The present disclosure provides a technique for improving reliability of an in-vehicle device.

According to an aspect of the disclosure, an in-vehicle device is capable of accessing a cloud via a communication unit of a vehicle. The in-vehicle device includes a first controller and a second controller. The first controller has at least one physical core configured to execute a first unit to execute processing related to control of hardware, and a second unit to execute processing related to provision of a service. The second controller is configured to start the first controller in response to occurrence of a start trigger. The first controller is configured to start the first unit earlier than the second unit when the first controller is started by the second controller. The second controller is configured to detect an abnormality of the first unit and an abnormality of the second controller. The first unit is configured to detect an abnormality of the second unit. The second controller is configured to restart the first unit and the second unit when the abnormality of the first unit or the abnormality of the second unit is detected. The second controller is configured to restart the first unit, the second unit and the second controller when the abnormality of the second controller is detected.

According to the above configuration, the abnormalities in the first and second units and the second controller can be reliably detected. When the abnormality of the first or second unit is detected, the first and second units are restarted. When the abnormality of the second controller is detected, the first and second units and the second controller are restarted. Therefore, it is possible to cope with the abnormalities of the first and second units and the abnormality of the second controller. Therefore, the reliability of the in-vehicle device can be improved.

In the in-vehicle device, the procedure executed by the first and second controllers may be provided as a method for starting the in-vehicle device. According to the starting method, the same effect can be obtained.

Hereinafter, an embodiment of the present disclosure will be described with reference to the drawings.

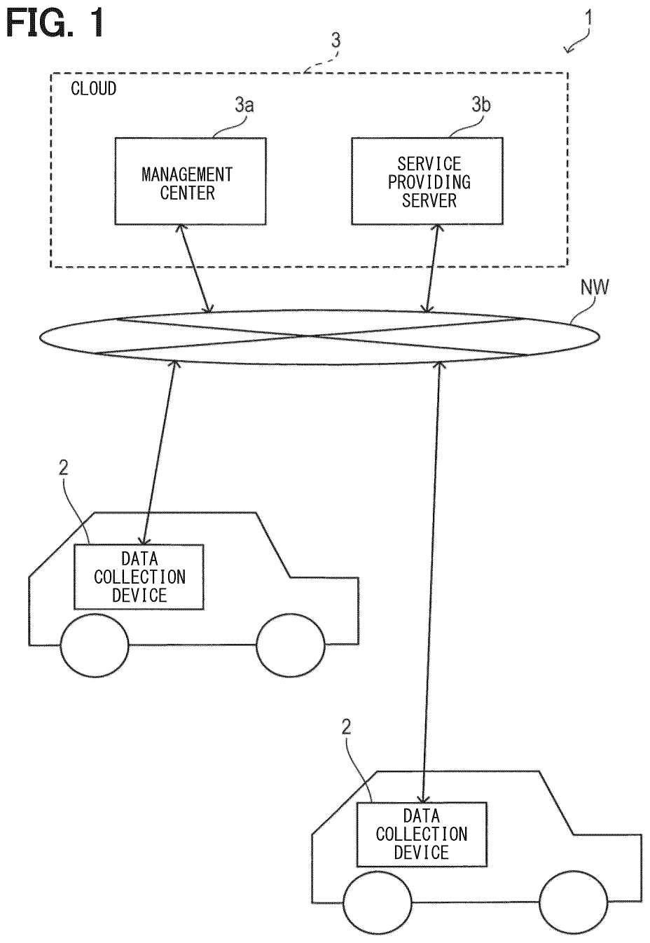

As illustrated in FIG. 1, a mobility loT system 1 of the present embodiment includes multiple data collection devices 2 that can access a cloud 3 via a wide area wireless communication network NW, and a management center 3a and a service providing server 3b provided by the cloud 3. loT is an abbreviation for Internet of Things.

A data collection device 2 is mounted on a vehicle and has a function of executing data communication with the management center 3a. Hereinafter, the vehicle on which the data collection device 2 is mounted is referred to as a subject vehicle.

The management center 3a manages the mobility loT system 1. The management center 3a has a function of executing data communication between the multiple data collection devices 2 and the service providing server 3b via the wide area wireless communication network NW.

The service providing server 3b is, for example, a server for providing services for managing operations of vehicles. The mobility loT system 1 may include multiple service providing servers having different service contents.

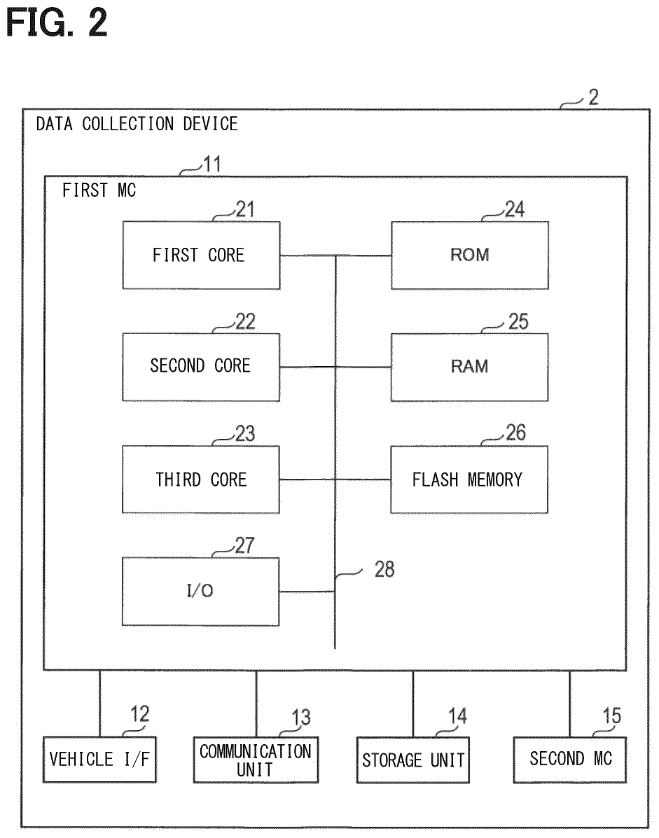

As illustrated in FIG. 2, the data collection device 2 includes a first MC 11, a vehicle I/F 12 (vehicle interface), a communication unit 13, a storage unit 14, and a second MC 15. MC is an abbreviation for microcontroller.

The first MC 11 includes first to third cores 21, 22, 23 which are physical cores, a ROM 24, a RAM 25, a flash memory 26, an input/output unit 27, and a bus 28.

Various functions of the first MC 11 are implemented by the first to third cores 21 to 23 executing a program stored in a non-transitory tangible storage medium. In this example, the ROM 24 and the RAM 25 correspond to the non-transitory tangible storage medium storing the program. A method corresponding to the program is executed by executing the program. Some or all of the functions implemented by the first to third cores 21 to 23 may be implemented by hardware such as at least one IC.

The flash memory 26 is a data rewritable nonvolatile memory.

The input/output unit 27 is a circuit for inputting and outputting data between an outside of the first MC 11 and the first to third cores 21 to 23.

The bus 28 connects the first to third cores 21 to 23, the ROM 24, the RAM 25, the flash memory 26, and the input/output unit 27 so that data can be input and output to and from each other.

The vehicle I/F 12 is an input/output circuit for inputting and outputting signals between the data collection device 2 and other electronic control units, sensors, and the like. The vehicle I/F 12 includes, for example, a power supply voltage input port, a general-purpose input/output port, a CAN communication port, an Ethernet communication port, a wireless LAN communication port, a short-range wireless communication port, a GPS communication port, and a camera communication port.

The power supply voltage input port is connected to a battery of the subject vehicle that is a power supply for the data collection device 2, and a voltage of the power supply is input to the power supply voltage input port.

The CAN communication port is a port for transmitting and receiving data in accordance with a CAN communication protocol. The Ethernet communication port is a port for transmitting and receiving data based on an Ethernet communication protocol. CAN is an abbreviation for Controller Area Network. Both CAN and Ethernet are registered trademarks.

The CAN communication port and the Ethernet communication port are connected to other electronic control units mounted on the subject vehicle. Accordingly, the data collection device 2 can transmit and receive a communication frame to and from the other electronic control units.

The wireless LAN communication port is a port for transmitting and receiving data via a wireless LAN. The short-range wireless communication port is a port for transmitting and receiving data by a short-range wireless communication technology such as Bluetooth (registered trademark). These ports are connectable to a communication controller, and the data collection device 2 transmits and receives data to and from the other electronic control units via the communication controller connected to the ports.

The GPS communication port is a port to which a device provided with a GPS is connected, and the data collection device 2 controls the GPS via the GPS communication port.

The camera communication port is a port to which a camera mounted on the subject vehicle is connected. The camera is configured to image the surroundings of the subject vehicle and/or the inside of the subject vehicle, and the data collection device 2 controls the camera via the camera communication port.

In addition, the general-purpose input/output port of the vehicle I/F 12 is connected to various devices such as a device for performing machine learning or a monitor.

The communication unit 13 is connected to the data collection device 2 via the communication port. For example, the communication unit 13 accesses the wide area wireless communication network NW by wireless communication according to a communication standard such as LTE, and executes data communication with the cloud 3 via the wide area wireless communication network NW.

The storage unit 14 is a storage device for storing various data.

The second MC 15 starts and stops the first MC 11. The second MC 15 is configured to execute processing with a high real-time responsiveness, and has a lower processing load than the first MC 11.

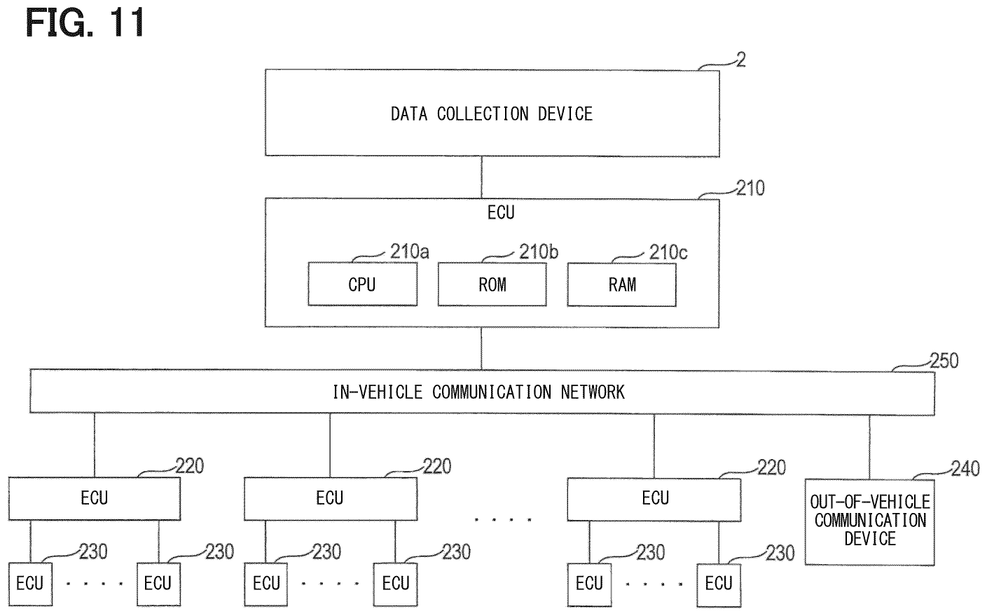

As illustrated in FIG. 11, one ECU 210, multiple ECUs 220, multiple ECUs 230, an out-of-vehicle communication device 240, and an in-vehicle communication network 250 are mounted on the subject vehicle. ECU is an abbreviation for Electronic Control Unit.

The ECU 210 integrally controls the multiple ECUs 220 to execute controls in cooperation with each other in the entire vehicle.

Each ECU 220 is provided for each of domains divided according to functions in the vehicle, and mainly controls the multiple ECUs 230 existing in the domain. Each ECU 220 is connected to subordinate ECUs 230 via a lower-layer network (e.g., CAN) provided individually. Each ECU 220 has a function of centrally managing access authority to the subordinate ECUs 230 and executing user authentication and the like. The domains are, for example, a powertrain domain, a body domain, a chassis domain, and a cockpit domain.

The ECUs 230 connected to the ECU 220 belonging to the powertrain domain include, for example, an ECU 230 that controls an engine, an ECU 230 that controls a motor, and an ECU 230 that controls the battery.

The ECUs 230 connected to the ECU 220 belonging to the body domain include, for example, an ECU 230 that controls an air conditioner, and an ECU 230 that controls a door.

The ECUs 230 connected to the ECU 220 belonging to the chassis domain include, for example, an ECU230 that controls braking, and an ECU 230 that controls steering.

The ECUs 230 connected to the ECU 220 belonging to the cockpit domain includes, for example, an ECU 230 that controls display of a meter and navigation, and an ECU230 that controls an input device operable by an occupant of the vehicle.

The out-of-vehicle communication device 240 executes data communication with a communication device outside the vehicle (e.g., a cloud server) via the wide area wireless communication network NW.

The in-vehicle communication network 250 includes a CAN FD and Ethernet. CAN FD is an abbreviation for CAN with Flexible Data Rate. The CAN FD connects the ECU 210 to each of the ECUs 220 and the out-of-vehicle communication device 240 via a bus. The Ethernet individually connects the ECU 210 to each of the ECUs 220 and the out-of-vehicle communication device 240.

The ECU 210 is an electronic control unit mainly composed of a microcontroller including a CPU 210a, a ROM 210b, and a RAM 210c. Various functions of the microcontroller are implemented by the CPU 210a executing a program stored in a non-transitory tangible storage medium. In this example, the ROM 210b corresponds to the non-transitory tangible storage medium in which the program are stored. A method corresponding to the program is executed by executing the program. Some or all of the functions executed by the CPU 210a may be configured as hardware by one or multiple ICs. Further, the number of microcontrollers constituting the ECU 210 may be one or more.

Like the ECU 210, the ECUs 220, the ECUs 230, and the out-of-vehicle communication device 240 are each an electronic control unit mainly including a microcontroller including a CPU, a ROM and a RAM. The number of microcontrollers constituting each of the ECUs 220, each of the ECUs 230, and the out-of-vehicle communication device 240 may be one or more. Each ECU 220 is an ECU that controls one or more ECUs 230. The ECU 210 is an ECU that controls one or more ECUs 220 or controls the ECUs 220, 230 of the entire vehicle including the out-of-vehicle communication device 240.

The data collection device 2 is connected to the ECU 210 so as to be capable data communication with the ECU 210 is possible. That is, the data collection device 2 receives information of the ECUs 210, 220, 230 via the ECU 210. In addition, the data collection device 2 transmits a request related to vehicle control to the ECU 210 or transmits the request to the ECUs 220, 230 via the ECU 210.

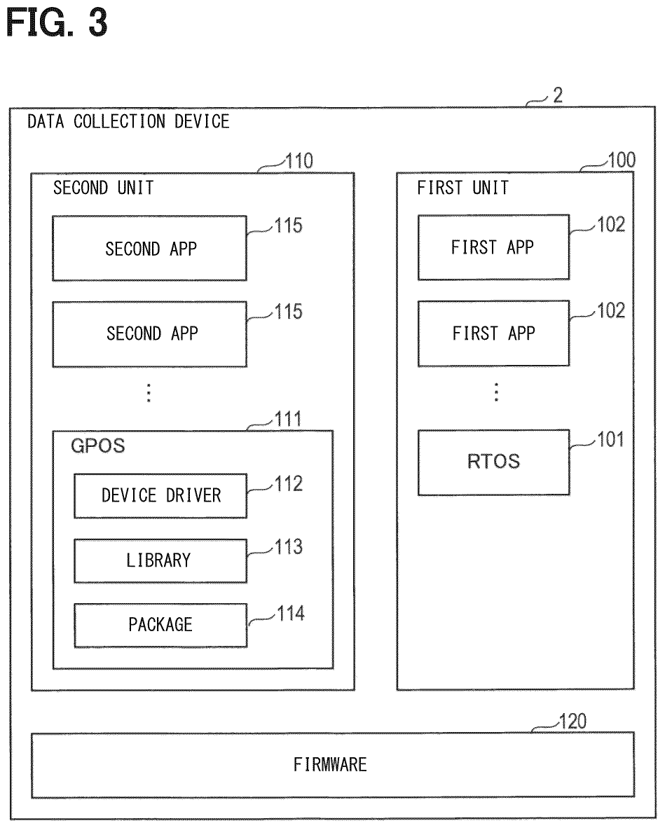

The first MC 11 of the data collection device 2 executes a program stored in the ROM 24 or a program loaded into the RAM 25. These programs include first and second units 100 and 110, and firmware 120 (see FIG. 3).

The first unit 100 is executed by the first core 21 and includes a RTOS (real-time operating system) 101 and at least one first app 102. However, the first unit 100 may not include the first app 102. The “app” is an abbreviation for an application. In the present embodiment, the first unit 100 includes, as an example, multiple first apps 102. The first app 102 mainly performs processing related to control of hardware, and the processing executed by the first app 102 requires a high real-time responsiveness. In addition, the RTOS 101 operates the first app 102 so as to ensure the real-time responsiveness of the processing required by the first app 102. For example, the first app 102 controls a camera (not illustrated) connected to the data collection device 2, communicates with an ECU connected to the data collection device 2, and gives an instruction to another electronic control unit via the ECU.

The second unit 110 is executed by the second core 22 and includes a GPOS (general purpose operating system) 111 and at least one second app 115. In the present embodiment, the second unit 110 includes, as an example, multiple second apps 115. The second app 115 mainly executes processing for providing a service to a user. More specifically, the second app 115 may execute a process for a service provided by the cloud 3, or may execute a process for a service provided without cooperating with the cloud 3. The processing executed by the second app 115 does not require a high real-time responsiveness. The GPOS 110 is basic software that operates the second app 115 without ensuring the high real-time responsiveness. For example, Linux (registered trademark) may be used as the GPOS 111.

The GPOS 111 includes a device driver 112, a library 113, and a package 114, which constitute software resources in the GPOS 111. The device driver 112 is a program for controlling hardware resources provided in or around the first MC 11. The library 113 and the package 114 are programs for executing specific functions.

The GPOS 111 includes a container engine, and all or a part of the second apps 115 operating in the GPOS 111 are virtualized via container-based virtualization. A second app 115 that has been virtualized via container-based virtualization is configured to execute processing using the device driver 112, the library 113, and the package 114 provided in the GPOS 111.

Of course, the second unit 110 may include a second app 115 that has not been virtualized via container-based virtualization. This second app 115 may also be configured to execute processing using the device driver 112, the library 113, and the package 114 provided in the GPOS 111.

The firmware 120 is executed by the third core 23, and performs a boot process of the first MC 11 and starts and stops the first and second units 100, 110.

A part of the RAM 25 of the first MC 11 is configured as a shared memory accessible by the first to third cores 21 to 23. The first and second units 100, 110 and the firmware 120 (i.e., the first to third cores 21 to 23) transmit and receive data via the shared memory and the bus 28.

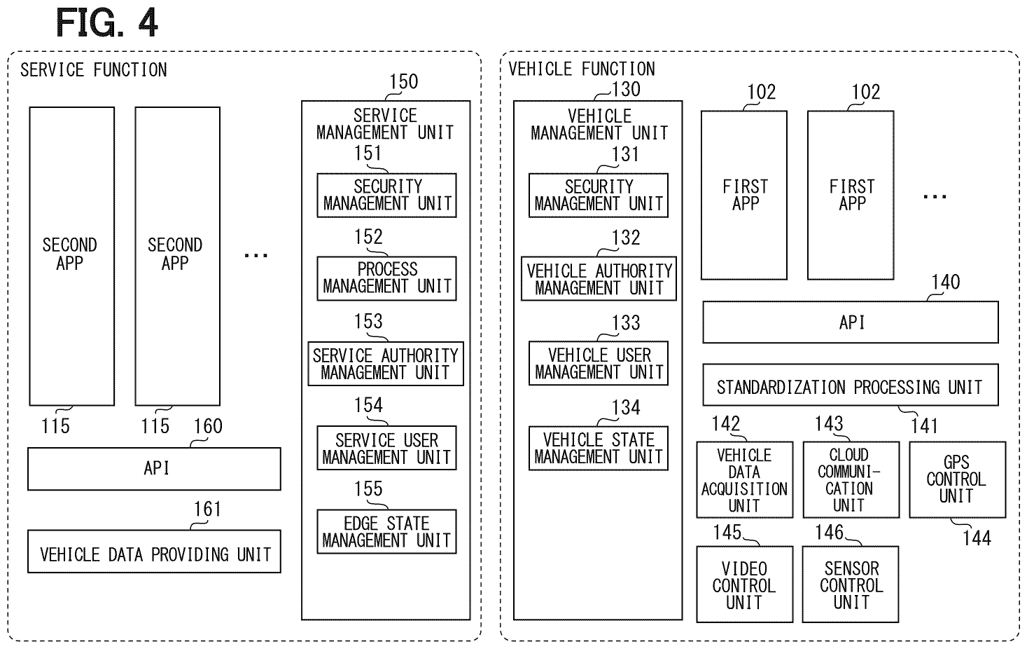

The first MC 11 of the data collection device 2 executes processing for providing a vehicle function and a service function (see FIG. 4). The vehicle function is mainly a function related to control of the data collection device 2 and control of an electronic control unit connected to the data collection device 2. In addition, the data collection device 2 has a function as an edge that performs processing for realizing a service provided by the cloud 3. The service function corresponds to a function as an edge.

A part of the vehicle function is implemented by the first app 102 operated on the RTOS 101. In addition, programs for implementing the vehicle function include a vehicle management unit 130. The vehicle management unit 130 includes a security management unit 131, a vehicle authority management unit 132, a vehicle user management unit 133, and a vehicle state management unit 134.

The security management unit 131 provides a function related to security of the vehicle. For example, the security management unit 131 may execute a process for preventing falsification of vehicle data, such as a process for encryption of the vehicle data.

The vehicle authority management unit 132 restricts access to the vehicle data or the like in accordance with an authority of a user who uses the data collection device 2.

The vehicle user management unit 133 adds and deletes a user who uses the data collection device 2, and sets the authority of the user.

The vehicle state management unit 134 starts and stops the RTOS 101 and manages the power supply of the data collection device 2.

In addition, the programs for implementing the vehicle function include an API 140, a standardization processing unit 141, a vehicle data acquisition unit 142, a cloud communication unit 143, a GPS control unit 144, a video control unit 145, and a sensor control unit 146.

The API 140 provides an interface when the programs for implementing the vehicle function is used. The API 140 is configured to restrict the use of the programs in accordance with the authority given to the user.

The standardization processing unit 141 converts the vehicle data acquired by the vehicle data acquisition unit 142 into a standard format, and stores the converted vehicle data in the flash memory 26 as standardized vehicle data.

The vehicle data acquisition unit 142 acquires a communication frame including the vehicle data from an electronic control unit mounted on the subject vehicle via the vehicle I/F 12. The vehicle data is data indicating a state of the subject vehicle. For example, the vehicle data may correspond to a traveling state such as a vehicle speed and a steering angle, an attribute of the subject vehicle such as a vehicle type, and a remaining amount of fuel or a remaining level of a battery of the subject vehicle.

The cloud communication unit 143 communicates with the cloud 3 via the communication unit 13.

The GPS control unit 144 controls the GPS connected to the vehicle I/F 12 and detects the current location or the like of the subject vehicle.

The video control unit 145 controls a camera connected to the vehicle I/F 12 to capture an image of the surroundings or the inside of the subject vehicle and acquire captured image data.

The sensor control unit 146 controls a sensor (e.g., UWB) connected to the vehicle I/F 12 and acquires data detected by the sensor.

The security management unit 131, the vehicle state management unit 134, the vehicle data acquisition unit 142, the video control unit 145, and the sensor control unit 146 operate on the RTOS 101 and are included in the first unit 100. The vehicle authority management unit 132, the vehicle user management unit 133, the cloud communication unit 143, and the GPS control unit 144 operate on the GPOS 111, and are included in the second unit 110. On the other hand, the API 140 and the standardization processing unit 141 operate on the RTOS 101 and the GPOS 111, and are included in the first and second units 100, 110.

On the other hand, a part of the service function is implemented by the second apps 115 operated on the GPOS 111. For example, the second apps 115 may detect a suspicious person with a sensor such as the camera connected via the vehicle I/F 12, or may detect an accident of the subject vehicle with a collision sensor or the like connected via the vehicle I/F 12. In addition, programs for implementing the service function include a service management unit 150, an API 160, and a vehicle data providing unit 161. The service management unit 150 includes a security management unit 151, a process management unit 152, a service authority management unit 153, a service user management unit 154, and an edge state management unit 155.

The security management unit 151 executes processing for ensuring security when the data collection device 2 accesses the cloud 3. For example, the security management unit 151 executes encryption of data to be transmitted to the cloud 3, decryption of encrypted data received from the cloud 3, and processing for preventing unauthorized access to the cloud 3 and the data collection device 2.

The process management unit 152 is a program for managing processes executed on the GPOS 111, and allocates resources to these processes.

The service authority management unit 153 restricts access to a service provided by the cloud 3 in accordance with the authority given to the user.

The service user management unit 154 restricts access to a function installed in the subject vehicle according to the authority given to the user.

The edge state management unit 155 starts and stops the GPOS 111 and executes processing related to the power supply of the data collection device 2.

The API 160 provides an interface when the programs for implementing the service function is used. The API 160 is configured to restrict the use of the programs in accordance with the authority given to the user.

The vehicle data providing unit 161 transmits the standardized vehicle data stored in the flash memory 26 to the cloud 3. In the cloud 3, the state of the subject vehicle is reproduced as a digital twin that is a virtual space based on the received standardized vehicle data.

In addition, for example, the second unit 110, that is, the second apps 115 or the library 113 or the package 114 of the GPOS 111 may be provided with an image recognition function. Then, for example, the image recognition function may analyze image data captured by the camera to detect a suspicious person.

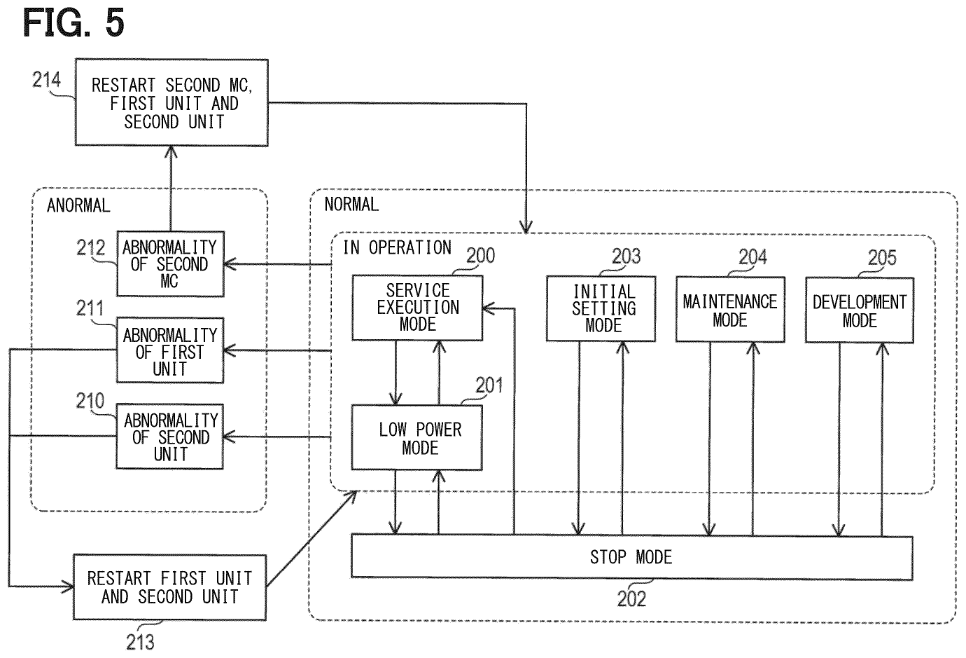

Operation modes of the data collection device 2 include at least a service execution mode 200, a low power mode 201, a stop mode 202, an initial setting mode 203, a maintenance mode 204, and a development mode 205 (see FIG. 5). During operation of the data collection device 2, one of the operation modes other than the stop mode 202 is selected as an operation mode of the data collection device 2.

The service execution mode 200 is an operation mode in which a service can be provided by the data collection device 2, and the first MC 11 and the second MC 15 are operating. That is, during the service execution mode 200, the first and second units 100 and 110 are operable.

The low power mode 201 is an operation mode in which power consumption of the data collection device 2 is reduced by stopping some functions of the data collection device 2. In the low power mode 201, at least the first and second units 100 and 110 in the first MC 11 are stopped. In the present embodiment, for example, the first MC 11 is stopped in the low power mode 201. In the low power mode 201, at least a part of the functions of the second MC 15 are operating.

The stop mode 202 is a mode in which the operation of the data collection device 2 is stopped. In the stop mode, the operations of the first MC 11 and the second MC 15 are stopped.

The initial setting mode 203 is an operation mode in which initial setting of the data collection device 2 can be executed, and the maintenance mode 204 is an operation mode in which maintenance of the data collection device 2 can be executed. The development mode 205 is an operation mode for work such as debugging at the time of development of the data collection device 2.

When one of start triggers occurs during the low power mode 201, the operation mode shifts to the service execution mode 200. Although details will be described later, in the present embodiment, for example, the start triggers include starting driving of the subject vehicle (e.g., turning on a power switch or a key switch), and receiving a starting instruction transmitted from the cloud 3 or another electronic control unit. Even during the low power mode 201, power is supplied from the battery to the data collection device 2. Therefore, the data collection device 2 can receive, for example, an instruction from the cloud 3 via the communication unit 13, and can receive an input from a sensor or another electronic control unit via the vehicle I/F 12.

In the service execution mode 200, when a driving stopping operation of the subject vehicle is performed and a driving stopped state continues for a predetermined waiting time, the operation mode shifts to the low power mode 201. The operation mode may be shifted to the low power mode 201 in response to an instruction from the cloud 3. The driving stopping operation means, for example, an operation of turning off the power switch or the key switch of the subject vehicle. The driving stopped state means, for example, a state in which the power switch or the key switch is turned off.

When the driving stopped state of the subject vehicle continues for a predetermined stop time (e.g., approximately 12 hours) during the low power mode 201, the operation mode shifts to the stop mode 202. In addition, during the low power mode 201, even before the stop time elapses, if a voltage of the power supply falls below a first threshold, the operation mode may shift to the stop mode 202. In addition, the operation mode may shift to the stop mode 202 in response to an instruction from the cloud 3.

In a case where the operation mode shifts from the low power mode 201 to the stop mode 202 due to the voltage of the power supply falling below the first threshold, the operation mode may shift from the stop mode 202 to the low power mode 201 when the voltage of the power supply exceeds a second threshold. The second threshold may be the same value as the first threshold or may be a value larger than the first threshold.

Further, the data collection device 2 is provided with a setting switch for setting an operation mode to which the operation mode of the data collection device 2 shifts from the stop mode 202. Then, in the stop mode 202, when the driving start operation of the subject vehicle is performed and the voltage of the power supply exceeds the second threshold, the operation mode shifts to any one of the service execution mode 200, the initial setting mode 203, the maintenance mode 204, and the development mode 205 according to the state of the setting switch.

During the initial setting mode 203, the maintenance mode 204, and the development mode 205, when an operation indicating completion of work against the data collection device 2 is detected, the operation mode shifts to the stop mode 202.

During the service execution mode 200, the process management unit 152 operated on the GPOS 111 monitors operations of the second apps 115. For example, when a second app 115 is detected to have an abnormality such as runaway, the second app 155 is restarted by the process management unit 152.

Further, as described above, the first unit 100 operating on the first core 21 of the first MC 11 includes the RTOS 101 having a high real-time responsiveness, and the second unit 110 operating on the second core 22 includes the GPOS 111 not having the high real-time responsiveness. The second unit 110 has a larger processing load than the first unit 100, and the first unit 100 has higher reliability than the second unit 110. Further, the second MC 15 executes processing with a high real-time responsiveness, and this processing has a lower load and higher reliability than the processing executed by each of the first and second units 100 and 110.

Therefore, during the service execution mode 200, the first unit 100 (e.g., the RTOS 101 or the first app 102) monitors the operation of the second unit 110. During the service execution mode 200, the second MC 15 monitors the operation of the first unit 100. During the service execution mode 200, the second MC 15 monitors the operation of the second MC 15 with, for example, a watchdog timer.

As shown in FIG. 5, when an abnormality of the second unit 110 is detected by the first unit 100 in state 210 and when an abnormality of the first unit 100 is detected by the second MC 15 in state 211, the first and second units 100 and 110 are restarted in state 213. When the abnormality of the second MC 15 is detected in state 212, the second MC 15 and the first and second units 100 and 110 are restarted in state 214.

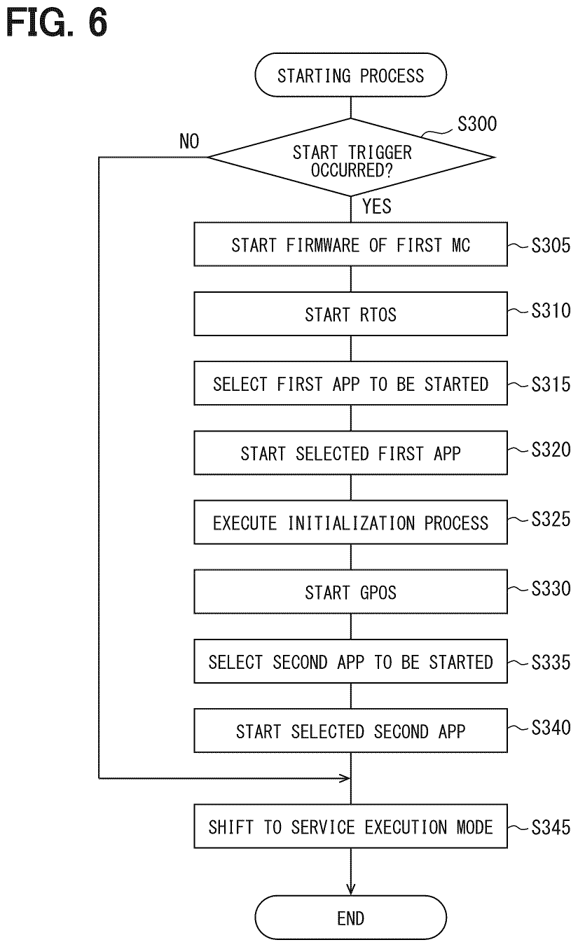

Next, referring to a flowchart of FIG. 6, a starting process will be described. In the starting process, the first and second units 100 and 110 are started in response to an occurrence of one of the start triggers during the low power mode, and the operation mode shifts to the service execution mode.

In the present embodiment, for example, the following multiple start triggers are provided.

(a) The vehicle I/F 12 receives a notification that a driving start operation of the subject vehicle has been performed.

(b) The communication unit 13 receives a starting instruction from the cloud 3.

(c) The vehicle I/F 12 receives a start instruction from another electronic control unit via, for example, CAN, Ethernet, wireless LAN, or short-range wireless communication.

When a start trigger occurs, a start signal is output from the vehicle I/F 12 or the communication unit 13 to the second MC 15.

In addition, the start triggers may include, for example, detecting a predetermined event by a sensor connected to the data collection device 2. More specifically, for example, the second MC 15 may be connected to a proximity sensor that detects an approach of an object such as a suspicious person to the subject vehicle, and the proximity sensor may output a signal to the second MC 15 when detecting the approach. This output signal from the proximity sensor may be used as the start signal. Further, for example, the second MC 15 may be connected to a vibration sensor that detects vibration caused by a collision with the subject vehicle, and the vibration sensor may output a signal to the second MC 15 when detecting the vibration. This output signal from the vibration sensor may be used as the start signal.

During the low power mode, the second MC 15 periodically monitors the presence or absence of the input of the start signal, and when the start signal is input (Yes in step S300), the first MC 11 is started in step S305. At this time, in the first MC 11, the firmware 120 is started by an instruction from the second MC 15, and the boot process is started. At this time, the second MC 15 determines which start trigger has occurred based on the start signal or the like, and notifies the first MC 11 of a determination result.

Then, the firmware 120 starts the first unit 100. More specifically, the firmware 120 starts the RTOS 101 (S310). For example, it takes about 700 milliseconds to start the RTOS 101. Thereafter, the RTOS 101 selects a first app 102 among the first apps 102 according to the start trigger in step S315, and starts the selected first app 102 in step S320. Thereby, a control of hardware selected according to the start trigger is started. Alternatively, the firmware 120 may start the RTOS 101 after the initialization process described later is started in step S325 and before the initialization process is completed. Further, the firmware 120 may determine whether to start the RTOS 101 based on an occurred start trigger, and start the RTOS 101 (i.e., first unit 100) when a specific start trigger occurs.

After the RTOS 101 is started, the firmware 120 executes the initialization process in step S325. In the initialization process, the second unit 110 is initialized. For example, the kernel of the GPOS 111 is loaded into a main memory (i.e., RAM 25). In addition, in the initialization process, setting of a port of the second core 22 or the like may be executed.

When the initialization process is completed, the firmware 120 starts the second unit 110. More specifically, the firmware 120 starts the GPOS 111 in step S330. For example, it takes about 7 seconds to start the GPOS 111. Then, the GPOS 111 selects a second app 115 among the second apps 115 according to the start trigger in step S335, and starts the selected second app 115 in step S340. Accordingly, provision of the service selected in accordance with the start trigger is started. The firmware 120 may determine whether to start the GPOS 111 based on an occurred start trigger, and start the GPOS 111 (i.e., second unit 110) when a specific start trigger occurs.

Then, the operation mode shifts from the low power mode to the service execution mode in step S345.

As described above, during the stop mode 202, when the driving start operation of the subject vehicle is performed and the voltage of the power supply exceeds the second threshold, the operation mode shifts to the service execution mode 200 or the like according to the state of the setting switch. Also in this case, the first MC 11 is started by the same process as the starting process.

More specifically, when the voltage of the power supply exceeds the second threshold during the stop mode 202, and the driving start operation of the subject vehicle is performed, the start signal is input to the second MC 15, and the second MC 15 is started. Thereafter, the first MC 11 is started by the same process as the starting process. In this case, an application and an operating system to be started may be selected according to the state of the setting switch. In this case, in step S345, the operation mode shifts to any one of the service execution mode, the initial setting mode, the maintenance mode, and the development mode according to the state of the setting switch.

As described above, in the data collection device 2, when the operation mode shifts to the service execution mode, the application and the operating system to be started may be selected according to the start trigger.

More specifically, for example, the data collection device 2 can provide a digital key service for locking and unlocking the subject vehicle with a mobile terminal such as a smartphone. When providing the digital key service, the data collection device 2 controls a device mounted on the subject vehicle without cooperating with the cloud 3.

That is, in the low power mode, when a locking instruction or an unlocking instruction of the subject vehicle is issued from the mobile terminal to the data collection device 2 via the digital key service, the data collection device 2 shifts to the service execution mode and executes a process for locking or unlocking the subject vehicle.

When the digital key service is provided, the locking instruction and the unlocking instruction are included in the start triggers. When the locking instruction or the unlocking instruction is received from the mobile terminal, the vehicle I/F 12 outputs a start signal to the second MC 15, and the second MC 15 to which the start signal is input starts the first MC 11. The firmware 120 of the first MC 11 starts the RTOS 101 and does not start the GPOS 111. The RTOS 101 starts a first app 102 related to the digital key service among the first apps 102, and does not start the other first apps 102.

An instruction to start providing a service other than the digital key service may be included in the start triggers. When the operation mode shifts from the low power mode to the service execution mode due to occurrence of such a start trigger, the GPOS 111 and a part of the second apps 115 may be started and the RTOS 101 may not be started.

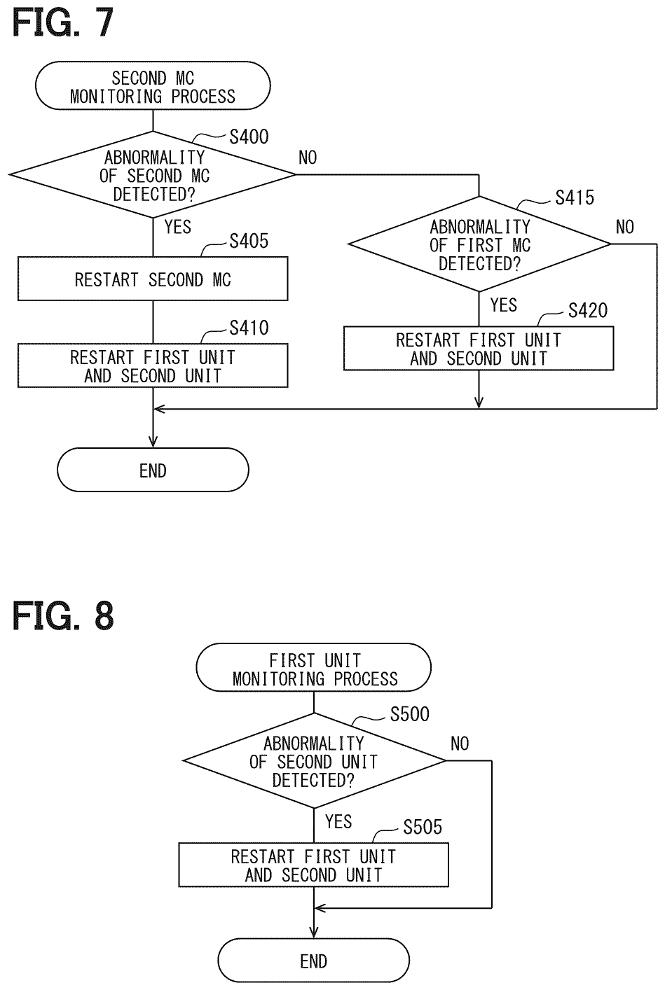

Next, with reference to a flowchart of FIG. 7, a second MC monitoring process will be described. In this process, the second MC 15 detects an abnormality in the first unit 100 and the second MC 15 during the service execution mode.

In the present embodiment, for example, the abnormality of the second MC 15 is detected by a watchdog timer which is a hardware resource of the second MC 15. Of course, the second MC 15 may detect the abnormality of the second MC 15 by a method other than the watchdog timer. When the abnormality of the second MC 15 is detected (Yes in step S400), the second MC 15 is reset and the second MC 15 is restarted in step S405.

Then, in step S410, the restarted second MC 15 resets the first MC 11 or the first and second cores 21 and 22, and then the first and second units 100 and 110 are started in the same manner as in steps S305 to S340 of the starting process. At this step, the firmware 120, the RTOS 101, and the GPOS 111 may start the operating system and the application that are operating immediately before the abnormality is detected.

On the other hand, when an abnormality is not detected by the watchdog timer (NO in step S400), the second MC 15 periodically determines whether an abnormality has occurred in the first unit 100 in step S415. More specifically, for example, the first unit 100 may periodically transmit a notification to the second MC 15, and it may be considered that an abnormality has occurred in the first unit 100 when there is no notification from the first unit 100.

When an abnormality occurs in the first unit 100 (Yes in step S415), the first MC 11 or the first and second cores 21 and 22 is reset in the same manner as in step S410, and then the first and second units 100 and 110 are started in step S420. Then, the process ends.

Next, with reference to a flowchart of FIG. 8, a first unit monitoring process will be described. In this process, the first unit 100 detects an abnormality in the second unit 110 during the service execution mode. The first unit monitoring process is periodically executed by, for example, the RTOS 101 or the first apps 102.

In step S500, the first unit 100 determines whether an abnormality has occurred in the second unit 110. More specifically, for example, the second unit 110 may periodically transmit a notification to the first unit 100, and it may be considered that an abnormality has occurred in the second unit 110 when there is no notification from the second unit 110. When an affirmative determination is obtained in step S500 (Yes in step S500), the process proceeds to step S505. When a negative determination is obtained in step S500 (No in step S500), the process ends.

In step S505, the first unit 100 notifies the second MC 15 of the abnormality of the second unit 110. Then, the second MC 15 resets the first MC 11 or the first and second cores 21 and 22. Thereafter, the first and second units 100 and 110 are started in the same manner as in steps S305 to S340 of the starting process, and the process ends. Depending on the abnormal state of the second unit 110, a software reset of the second unit 110 may be executed instead of the reset of the first MC 11.

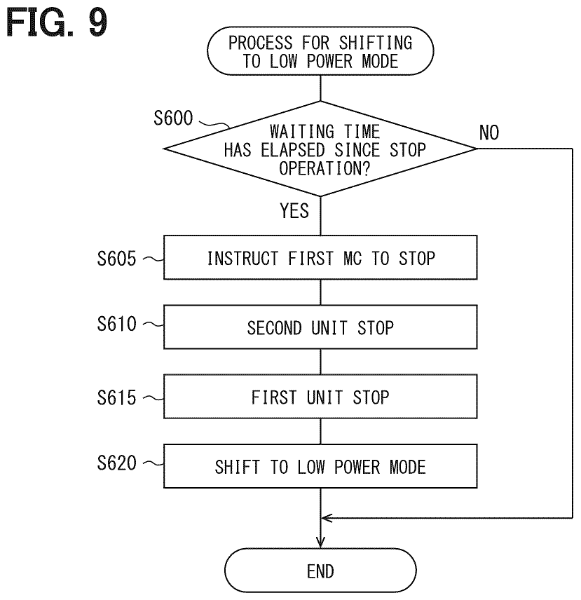

Next, with reference to a flowchart of FIG. 9, a low power mode transition process will be described. In this process, the operation mode shifts to the low power mode due to the driving stopping operation during the service execution mode. The low power mode transition process is periodically executed during the service execution mode.

In step S600, after detecting the driving stopping operation via the vehicle I/F 12, the second MC 15 determines whether the operation stopped state has continued for the waiting time. When an affirmative determination is obtained in step S600 (Yes in step S600), the process proceeds to step S605. When a negative determination is obtained in step S600 (No in step S600), the process ends.

In step S605, the second MC 15 instructs the first MC 11 to stop. Then, in the first MC 11 that has received the instruction, first, the second unit 110 is stopped in step S610. More specifically, for example, when the instruction is issued, the RTOS 101 may stop the process being executed on the GPOS 111, and then stop the GPOS 111 by, for example, a HALT command.

Then, when the GPOS 111 is stopped, the operation of the RTOS 101 stops in step S615. As a result, the first unit 100 stops in step S615, and the operation mode shifts to the low power mode in step S620.

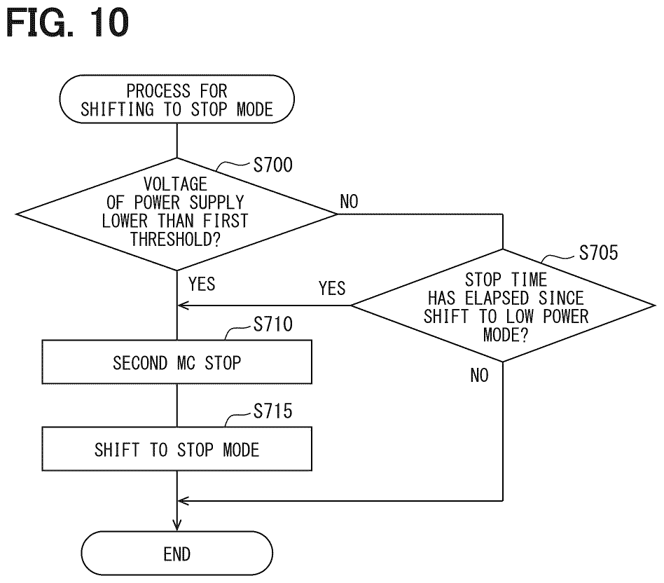

Next, with reference to a flowchart of FIG. 10, a stop mode transition process will be described. In this process, the operation mode shifts to the stop mode due to a voltage drop of the power supply or the like during the low power mode. The stop mode transition process is periodically executed during the low power mode.

In step S700, the second MC 15 determines whether the voltage of the power supply acquired via the vehicle I/F 12 is lower than the first threshold. When an affirmative determination is obtained in step S700 (Yes in step S700), the process proceeds to step S710. When a negative determination is obtained in step S700 (No in step S700), the process proceeds to step S705.

In step S705, the second MC 15 determines whether the low power mode has continued for the stop time. When an affirmative determination is obtained in step S705 (Yes in step S705), the process proceeds to step S710. When a negative determination is obtained in step S705 (No in step S705), the process ends.

In step S710, the operation of the second MC 15 is stopped, and the operation mode shifts to the stop mode in step S715. Then, the process ends.

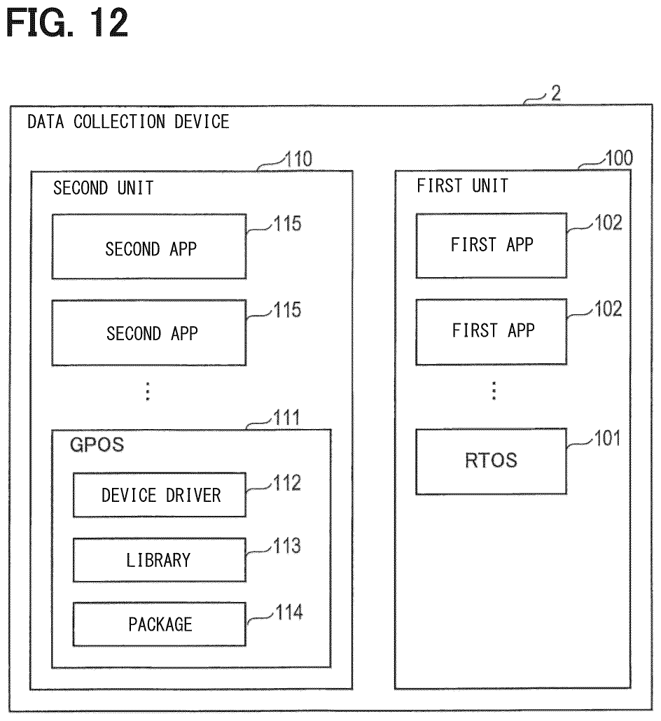

In the data collection device 2 of a modification, the first MC 11 includes the first and second cores 21 and 22 and does not include the third core 23. As a program for operating the first MC 11, the first and second units 100 and 110 are provided, but the firmware 120 is not provided as shown in FIG. 12.

The processes executed by the firmware 120 is executed by the RTOS 101 of the first unit 100. That is, the boot process of the first MC 11 and the start and stop of the second unit 110 are executed by the RTOS 101. These processes may be executed by a program other than the RTOS 101 of the first unit 100.

More specifically, when the first MC 11 is started in step S305 of the starting process, the firmware 120 is not started, and the RTOS 101 is started in accordance with the starting of the first MC 11 and the boot process is started in subsequent step S310.

In step S325 of the starting process, the RTOS 101 executes an initialization process. When the initialization process is completed, the RTOS 101 starts the second unit 110 (more specifically, GPOS 111) in step S330. The RTOS 101 may determine whether to start the GPOS 111 based on a start trigger that has occurred, and may start the GPOS 111 (i.e., second unit 110) when a specific start trigger has occurred.

According to the above embodiment, the following effects are obtained.

(1) According to the above embodiment, the processing in the first unit 100 has a lower load and higher reliability than the processing in the second unit 110. The processing in the second MC 15 has a lower load and higher reliability than the processing in the first unit 100. The abnormality of the second unit 110 is detected by the first unit 100, and the abnormality of the first unit 100 is detected by the second MC 15. The abnormality of the second MC 15 is detected by the second MC 15 itself. Therefore, an abnormality in the first and second units 100 and 110 and the second MC 15 can be detected accurately.

When an abnormality is detected in the first unit 100 or the second unit 110, the first and second units 100, 110 are restarted. When an abnormality of the second MC 15 is detected, the first and second units 100 and 110 and the second MC 15 are restarted. Therefore, it is possible to appropriately cope with the abnormality of the first and second units 100 and 110 and the abnormality of the second MC 15. Therefore, the reliability of the data collection device 2 can be improved.

(2) When the first MC 11 is started by the second MC 15, the firmware 120 starts the RTOS 101 and then starts the GPOS 111. Therefore, the RTOS 101 and the GPOS 111 can be suitably started.

(3) On the other hand, in the modification, the firmware 120 is not provided in the first MC 11. When the first MC 11 is started by the second MC 15, the RTOS 101 is started, and the RTOS 101 starts the GPOS 111. Even with such a configuration, the RTOS 101 and the GPOS 111 can be suitably started.

(4) As one of the start triggers of the data collection device 2, the starting instruction from the cloud 3 is provided. Therefore, the convenience of the data collection device 2 is improved.

(5) In the low power mode, when a start trigger occurs, the first MC 11 starts the first unit 100 that executes processing related to control of hardware, and then starts the second unit 110 that executes processing related to provision of a service. Therefore, when the data collection device 2 is started, collection of data necessary for providing the service can be started at an early stage in the data collection device 2. Therefore, it is possible to provide the service based on data collected at the early stage after the starting of the data collection device 2.

(6) The operation modes of the data collection device 2 include the service execution mode 200, the low power mode 201, and the stop mode 202. Then, the operation mode changes according to occurrence of a start trigger or an operation of stopping the driving of the subject vehicle, for example. Therefore, it is possible to suitably start and stop the data collection device 2.

(7) When the driving start operation is performed during the stop mode 202, the operation mode shifts to the service execution mode 200 without going through the low power mode 201. Therefore, the provision of the service can be quickly started.

(8) In addition, the first unit 100 executes at least a process for collecting information related to the subject vehicle and/or information detected via a sensor mounted on the subject vehicle. The second unit 110 executes at least an image recognition process. Therefore, it is possible to suitably assign the processes to each of the first unit 100 and the second unit 110.

(9) When the operation mode shifts from the In the service execution mode to the low power mode in response to the driving stopping operation, the operation of the second unit 110 is first stopped, and then the operation of the first unit 100 is stopped in the first MC 11. More specifically, when the second unit 110 is stopped, the RTOS 101 stops the process being executed on the GPOS 111 and then stops the GPOS 111. Therefore, it is possible to prevent unnecessary data from remaining in the main memory in which the second unit 110 is loaded. In addition, it is possible to reduce interruption of access to the storage (e.g., the flash memory 26 and the storage unit 14) in the second unit 110 due to the stop of the second unit 110, and thus, destruction of the storage is reduced.

(10) In the second unit 110, the second app 115 that has been virtualized via container-based virtualization executes processing with software resources of the GPOS 111. Therefore, the data size of the second app 115 can be reduced, and the load on the second core 22 during the operation of the second app 115 can be reduced.

In addition, since a software resource whose quality has been verified by the second app 115 can be used, reliability is improved.

(11) When the data collection device 2 in the low power mode is started, the first and second apps 102 and 115 to be started are selected according to an occurred start trigger. Therefore, it is possible to avoid starting of an unnecessary app, and it is possible to quickly start provision of a necessary service in response to occurrence of a start trigger.

(12) Further, when the data collection device 2 in the low power mode is started, a unit to be started is selected according to a start trigger. Therefore, it is possible to avoid starting of an unnecessary unit, and it is possible to quickly start provision of a necessary service in response to occurrence of a start trigger.

Although the embodiment of the present disclosure has been described above, the present disclosure is not limited to the embodiment described above, and various modifications can be made to implement the present disclosure.

(1) In the above embodiment, the first MC 11 of the data collection device 2 includes the first to third cores 21 to 23. However, the number of physical cores in the first MC 11 is not limited to three, and may be appropriately determined. More specifically, for example, a core that operates the firmware 120 may be provided in the data collection device 2, a virtual machine environment may be established, and the RTOS 101 and the GPOS 111 may be operated by one, three or more cores. In addition, for example, a virtual machine environment may be established, and the firmware 120, the RTOS 101, and the GPOS 111 may be operated by 2 or less cores or 3 or more cores. Even in the case of having such a configuration, it is possible to start and stop the first unit 100 and the second unit 110 in the same manner as in the above-described embodiment.

(2) Multiple functions of one element in the above embodiment may be implemented by multiple elements, or a single function of one element may be implemented by multiple elements. Further, multiple functions of multiple elements may be implemented by one element, or one function implemented by multiple elements may be implemented by one element. A part of the configuration of the above embodiment may be omitted. Further, at least part of the configuration of the above-described embodiment may be added to or replaced with the configuration of another embodiment described above.

(3) In addition to the data collection device 2 described above, the present disclosure may be implemented in various forms such as a program for causing a computer to function as the first MC 11 and the second MC 15 of the data collection device 2, a non-transitory tangible storage medium such as a semiconductor memory in which the program is stored, and a method implemented by the program. Further, the present disclosure can be implemented in various forms such as a method implemented by the data collection device 2, a method implemented by the first MC 11 and/or the second MC 15, and a method of starting the data collection device 2.

The data collection device 2 corresponds to an example of an in-vehicle device, the first MC 11 of the data collection device 2 corresponds to an example of a first controller, and the second MC 15 corresponds to an example of a second controller.

The microcontrollers and methods described in the present disclosure may be implemented by a special purpose computer created by configuring a memory and a processor programmed to execute one or more particular functions embodied in computer programs. Alternatively, the microcontrollers and methods described in the present disclosure may be implemented by a special purpose computer created by configuring a processor provided by one or more special purpose hardware logic circuits. Alternatively, the microcontrollers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. An in-vehicle device capable of accessing a cloud via a communication unit of a vehicle, the in-vehicle device comprising:
a first controller having at least one physical core configured to execute
a first unit to execute processing related to control of hardware, and
a second unit to execute processing related to provision of a service; and
a second controller configured to start the first controller in response to occurrence of a start trigger, wherein
the first controller is configured to start the first unit and then start the second unit when the first controller is started by the second controller,
the second controller is configured to detect an abnormality of the first unit and an abnormality of the second controller,
the first unit is configured to detect an abnormality of the second unit, and
the second controller is configured to
restart the first unit and the second unit when the abnormality of the first unit or the abnormality of the second unit is detected, and
restart the first unit, the second unit and the second controller when the abnormality of the second controller is detected.

2. The in-vehicle device according to claim 1, wherein,
the first unit includes a first operating system,
the second unit includes a second operating system, and
the at least one physical core is configured to execute firmware to start the first operating system and then start the second operating system when the first controller is started by the second controller.

3. The in-vehicle device according to claim 1, wherein
the first unit includes a first operating system,
the second unit includes a second operating system, and
the first operating system is configured to start the second operating system when the first controller is started by the second controller.

4. The in-vehicle device according to claim 1, wherein
the start trigger includes at least receiving of a starting instruction from the cloud by the communication unit.

5. The in-vehicle device according to claim 1, wherein
operation modes of the in-vehicle device include at least a service execution mode in which the first unit and the second unit are operable and the second controller operates, a low power mode in which the first unit and the second unit are stopped and at least one of functions of the second controller operates, and a stop mode in which the first unit, the second unit and the second controller are stopped,
the second controller is configured to operate to implement the low power mode when the first unit and the second unit are stopped due to a driving stopping operation of the vehicle during the service execution mode,
the second controller is configured to operate to implement the service execution mode when the first unit and the second unit are started in response to occurrence of the start trigger during the low power mode, and
the second controller is configured to stop operating to implement the stop mode when a voltage of a power supply to the in-vehicle device decreases during the low power mode.

6. The in-vehicle device according to claim 5, wherein
the second controller is configured to start operating and start the first controller to implement the service execution mode when the voltage of the power supply exceeds a predetermined threshold value and a driving start operation of the vehicle is received during the stop mode.

7. The in-vehicle device according to claim 1, wherein
the first unit includes at least a process for collecting information relating to the vehicle and/or information detected via a sensor mounted on the vehicle, and
the second unit includes at least an image recognition process.

8. The in-vehicle device according to claim 1, wherein
the second controller is configured to transmit a stop instruction to the first controller to stop in response to receiving a driving stop operation of the vehicle during a service execution mode in which the first unit and the second unit are operable and the second controller operates, and
the first controller is configured to stop the second unit and then stop the first unit when receiving the stop instruction from the second controller during the service execution mode.

9. The in-vehicle device according to claim 1, wherein
the second unit includes at least one application that has been virtualized via container-based virtualization and an operating system that operates the at least one application, and
the at least one application is configured to execute processing using a software resource provided in the operating system.

10. The in-vehicle device according to claim 1, wherein
the first unit includes at least one first application,
the second unit comprises at least one second application,
the second controller is configured to start the first controller in response to occurrence of one of multiple start triggers,
the first unit is configured to start a first application corresponding to a start trigger that has occurred, when the first unit is started by the first controller, and
the second unit is configured to start a second application corresponding to a start trigger that has occurred, when the second unit is started by the first controller.

11. The in-vehicle device according to claim 1, wherein
the second controller is configured to start the first controller in response to occurrence of one of multiple start triggers, and
the first controller is configured to start the first unit and the second unit depending on the start trigger that has occurred.

12. A method for starting an in-vehicle device capable of accessing a cloud via a communication unit of a vehicle, the in-vehicle device including
a first controller having at least one physical core configured to execute
a first unit to execute processing related to control of hardware, and
a second unit to execute processing related to provision of a service, and
a second controller, the method comprising:
starting the first controller by the second controller in response to occurrence of a start trigger;
starting the first unit and then starting the second unit by the first controller in response to the first controller being started by the second controller;
restarting the first unit and the second unit in response to an abnormality of the first unit being detected by the second controller or an abnormality of the second unit being detected by the first unit, and
restarting the first unit, the second unit and the second controller when an abnormality of the second controller is detected by the second controller.

13. An in-vehicle device capable of accessing a cloud via a communication unit of a vehicle, the in-vehicle device comprising:
a first controller including at least one processor and at least one memory that stores instructions configured to, when executed by the at least one processor, cause the at least one processor to
execute a first unit to execute processing related to control of hardware, and a second unit to execute processing related to provision of a service,
start the first unit and then start the second unit in response to the first controller being started, and
detect an abnormality of the second unit via the first unit; and
a second controller including at least one processor and at least one memory that stores instructions configured to, when executed by the at least one processor, cause the at least one processor to
start the first controller in response to occurrence of a start trigger,
detect an abnormality of the first unit and an abnormality of the second controller,
restart the first unit and the second unit when the abnormality of the first unit or the abnormality of the second unit is detected, and
restart the first unit, the second unit and the second controller when the abnormality of the second controller is detected.
